(19) United States
(12) Patent Application Publication
(10) Pub. No.: US 2017/0357466 A1
(43) Pub. Date: Dec. 14, 2017

(54) DATA STORAGE DEVICE AND OPERATING METHOD THEREOF

(71) Applicant: SK hynix Inc., Gyeonggi-do (KR)

(72) Inventor: Eu Joon BYUN, Gyeonggi-do (KR)

(21) Appl. No.: 15/261,052

(22) Filed: Sep. 9, 2016

(30) Foreign Application Priority Data
Jun. 14, 2016 (KR) 10-2016-0073725

(51) Int. Cl. G06F 3/06

(52) U.S. Cl. CPC G06F 3/0659; G06F 3/0679; G06F 3/061

(57) ABSTRACT

A data storage device includes a nonvolatile memory device; and a controller configured to generate a read command based on information on a memory region of the nonvolatile memory device corresponding to a read request and at least one memory region of the nonvolatile memory device corresponding to at least one stand-by read request, wherein the nonvolatile memory device simultaneously reads data stored in the memory region and data stored in the at least one memory region, in response to the read command.

### CROSS-REFERENCES TO RELATED APPLICATION

The present application claims priority under 35 U.S.C. §119(a) to Korean application number 10-2016-0073725, filed on Jun. 14, 2016, in the Korean Intellectual Property Office, which is incorporated herein by reference in its entirety.

### BACKGROUND

### 1. Technical Field

Various embodiments generally relate to a data storage device and, more particularly, to a data storage device including a nonvolatile memory device.

### 2. Related Art

Data storage devices store data provided by an external device response to a write request. Data storage devices also provide stored data to an external device in response to a read request. Examples of external devices that use data storage devices include computers, digital cameras, cellular phones and the like. Data storage devices may be embedded in an external device during manufacturing of the external devices or may be fabricated separately and then connected afterwards to an external device.

### SUMMARY

In an embodiment, a data storage device may include: a nonvolatile memory device; and a controller configured to generate a read command based on information on a memory region of the nonvolatile memory device corresponding to a read request and at least one memory region of the nonvolatile memory device corresponding to at least one stand-by read request, wherein the nonvolatile memory device simultaneously reads data stored in the memory region and data stored in the at least one memory region, in response to the read command.

In an embodiment, a data storage device may include: a nonvolatile memory device; and a controller configured to determine, based on information on a memory region of the nonvolatile memory device corresponding to a read request and at least one memory region of the nonvolatile memory device corresponding to at least one stand-by read request among a plurality of stand-by read requests, whether the read request is possible to be linked with the at least one stand-by read request, and cause the read request to stand by when the read request is not possible to be linked with the at least one stand-by read request.

In an embodiment, a method for operating a data storage device may include: determining, based on information on a memory region corresponding to a read request and at least one memory region corresponding to at least one stand-by read request, whether the read request is possible to be linked with the at least one stand-by read request; and causing the read request to stand by, when the read request is not possible to be linked with the at least one stand-by read request.

### BRIEF DESCRIPTION OF THE DRAWINGS

The above and other features and advantages of the present invention will become more apparent to those skilled in the art to which the present invention pertains by describing in detail various embodiments thereof with reference to the attached drawings in which:

FIG. 1 is a block diagram illustrating a data storage device comprising a nonvolatile memory device coupled to a controller, in accordance with an embodiment of the present invention.

FIG. 2A is a block diagram illustrating a configuration of the nonvolatile memory device shown in FIG. 1, in accordance with an embodiment of the present invention.

FIG. 2B is a diagram illustrating, a case where the nonvolatile memory device performs a read operation simultaneously for a plurality of planes.

FIG. 2C is a diagram illustrating a case where the nonvolatile memory device is not possible to perform a read operation simultaneously for planes.

FIG. 3 is a diagram illustrating an example of a read request generated by the request generation unit shown in FIG. 1.

FIG. 4 is a flow chart illustrating a method for operating the data storage device of FIG. 1, in accordance with an embodiment of the present invention.

FIG. 5 is a block diagram illustrating a solid state drive (SSD), in accordance with an embodiment of the present invention.

FIG. 6 is a block diagram illustrating a data processing system comprising a data storage device, in accordance with the embodiment of the present invention.

### DETAILED DESCRIPTION

Hereinafter, a data storage device and an operating method thereof according to the present invention will be described with reference to the accompanying drawings through exemplary embodiments of the present invention. The present invention may, however, be embodied in different forms and should not be construed being limited to the embodiments set forth herein. Rather, these embodiments are provided to describe the present invention in detail to the extent that a person skilled in the art to which the invention pertains can enforce the technical concepts of the present invention.

It is to be understood that embodiments of the present invention are not limited to the particulars shown in the drawings, that the drawings are not necessarily to scale, and, in some instances, proportions may have been exaggerated in order to more clearly depict certain features of the invention. While particular terminology is used, it is to be appreciated that the terminology used is for describing particular embodiments only and is not intended to limit the scope of the present invention. The terminology used herein is for the purpose of describing particular embodiments only and is not intended to be limiting of the present invention. As used herein, singular forms are intended to include the plural forms as well, unless the context dearly indicates otherwise. It will be further understood that the terms “comprises”, “comprising”, “includes”, and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and la scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, an element (also referred to as a feature) described in connection with one embodiment may be used singly or in combination with other elements of another embodiment, unless specifically indicated otherwise.

Hereinafter, the various embodiments of the present invention will be described in detail with reference to the attached drawings.

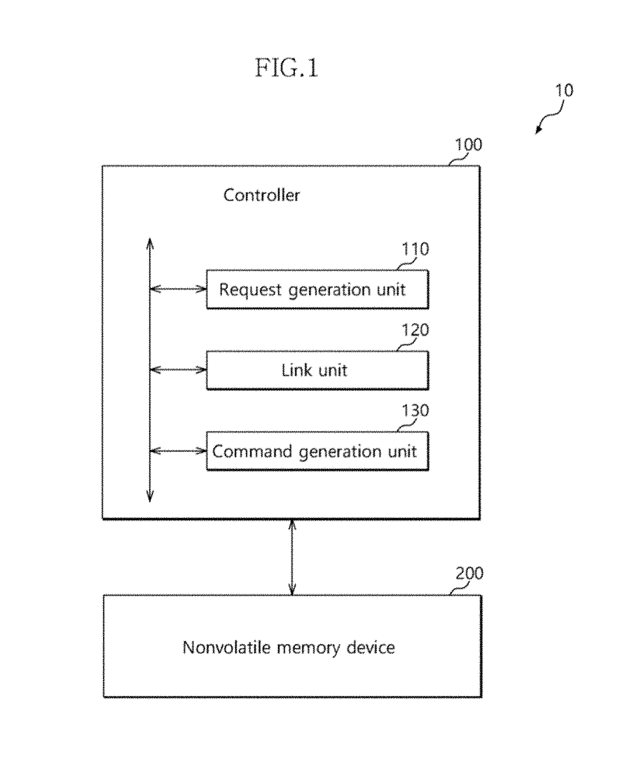

FIG. 1 is a block diagram illustrating a data storage device 10, in accordance with an embodiment of the present invention.

The data storage device 10 may be configured to store data la provided from an external device (not shown), in response to a write request from the external device. Also, the data storage device 10 may be configured to provide stored data to the external device, in response to a read request from the external device,

The data storage device 10 may be implemented in the form of a Personal Computer Memory Card International Association (PCMIA) card, a Compact Flash (CF) card, a smart media card, a memory stick, various multimedia cards (e.g., MMC, eMMC, RS-MMC, and MMC-Micro), various secure digital cards (e,g,, SD, Mini-SD, and Micro-SD), a Universal Flash Storage (UFS), a Solid State Drive (SSD) and the like.

The data storage device 10 may include a controller 100 and a nonvolatile memory device 200.

The controller 100 may control the operations of the data storage device 10. For example, the controller 100 may store data in the nonvolatile memory device 200, read data from the nonvolatile memory device 200 and output the read data to the external device, according to respective program and read requests received from the external device.

The controller 100 may include a request generation unit 110, a link unit 120, and a command generation unit 130.

The request generation unit 110 may generate a read request to read data from the nonvolatile memory device 200. The request generation unit 110 may generate a read request for each of various reasons. For example, the request generation unit 110 may generate read requests to read data requested from the external device, to read data necessary for the operation of the controller 100 and to manage data stored in the nonvolatile memory device 200. The read request may be generated by specifying the position of a memory region where a read operation is to be performed, in the nonvolatile memory device 200.

The link unit 120 may selectively link read requests generated by the request generation unit 110. For example, the link unit 120 may determine, based on a memory region corresponding to a read request and memory regions corresponding to one or more read requests waiting to be executed (also referred to hereinafter as stand-by read requests), whether the read request is possible to be linked with the stand-by read requests. When the read request is possible to be linked with the stand-by read requests, the link unit 120 may link the read request with the stand-by read requests. The link unit 120 may determine whether it is possible to perform linking, by determining whether the memory region corresponding to the read request and the memory regions corresponding to the stand-by read requests are possible to be read simultaneously. When a read request is not possible to be linked with at least one stand-by read request, the link unit 120 may delay execution of the read request and cause the read request to become a stand-by read request.

The command generation unit 130 may generate a read command based on a plurality of read requests linked by the link unit 120, and transmit the generated read command to the nonvolatile memory device 200.

That is to say, while the command generation unit 130 may transmit different read commands from respective read requests to the nonvolatile memory device 200, so that the nonvolatile memory device 200 performs read operations a multitude of times, the command generation unit 130 may generate one read command for a plurality of linked read requests and transmit the generated read command to the nonvolatile memory device 200 so that the nonvolatile memory device 200 reads simultaneously, through one read operation, data corresponding to the plurality of linked read requests. The term “link” means to correlate read requests so as to simultaneously read memory regions corresponding to the respective read requests.

Therefore, according to the present embodiment, since read operations which are otherwise to be performed a multitude of times are incorporated into one read operation, the operating speed of the data storage device 10 may be increased, and power consumption of the data storage device 10 may be reduced.

According to an embodiment, when it is determined that the number of read requests to be linked is insufficient even though it is determined that the read requests are possible to be linked, the link unit 120 may cause the read requests to stand by. For example, the link unit 120 may determine, based on a maximum number of memory regions capable of being read simultaneously, whether the number of read requests which are currently possible to be linked is sufficient.

The nonvolatile memory device 200 may store data received from the controller 100, and may read stored data and transmit the, read data to the controller 100, according to control of the controller 100.

The nonvolatile memory device 200 may include any one of a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), and the like.

While it is illustrated in FIG. 1 that the data storage device 10 includes only one nonvolatile memory device 200, it is to be noted that the embodiment is not limited thereto.

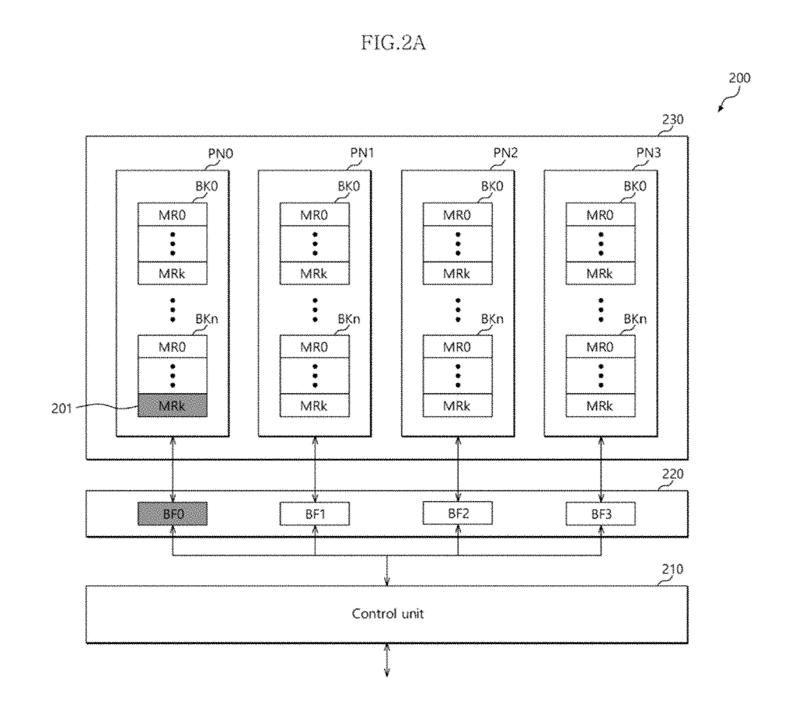

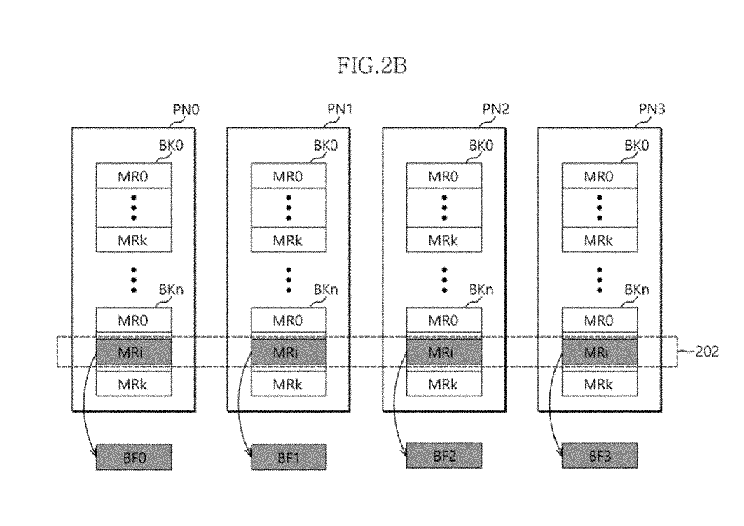

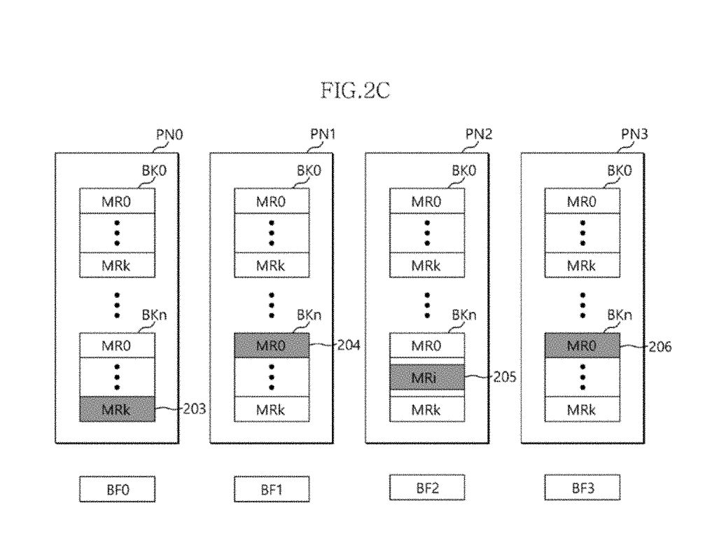

FIG. 2A is a block diagram illustrating the nonvolatile memory device 200 shown in FIG. 1.

The nonvolatile memory device 200 may include a control unit 210, a data input/output unit 220, and a data storage unit 230.

The control unit 210 may control the operations of the nonvolatile memory device 200 according to control of the controller 100 of FIG. 1. The control unit 210 may read data from a memory region of the data storage unit 230 in response to a read command received from the controller 100, and transmit the read data to the controller 100.

The data input/output unit 220 may transmit/receive data between the control unit 210 and the data storage unit 230. The la data input/output unit 220 may include a plurality of buffers BF0 to BF3 respectively corresponding to a plurality of planes PN0 to PN3.

The data storage unit 230 may include the planes PN0 to PN3. Each of the planes PN0 to PN3 may include a plurality of memory blocks BK0 to BKn. Each of the memory blocks BK0 to BKn may include a plurality of memory regions MR0 to mRk. A memory region may be a memory unit by which data is read to a corresponding buffer. For example, the data stored in a selected memory region 201 among the plurality of memory regions MR0 to MRk may be simultaneously read to the corresponding buffer BF0.

While it is illustrated in FIG. 2A that the data storage unit 230 includes four planes PN0 to PN3, it is to be noted that the embodiment is not limited thereto.

FIG. 28 is a diagram illustrating a case where the nonvolatile memory device 200 performs a read operation simultaneously for the planes PN0 to PN3.

Referring to FIG. 2B, the nonvolatile memory device 200 may perform a read operation simultaneously for the planes PN0 to PN3. The nonvolatile memory device 200 may read the data stored in selected memory regions 202 of the planes PN0 to PN3, to the respective buffers BF0 to BF3 due to the structural characteristic thereof. For example, the selected memory regions 202 may be memory regions which correspond to the same block address and the same row address in the respective planes PN0 to PN3. For example, the selected memory regions 202 may be memory regions which may be simultaneously accessed through a common word line.

Referring again to FIG. 1, when memory regions corresponding to a plurality of read requests may be read multaneously as shown in FIG. 2B, the link unit 120 may link the read requests. As a result, one read command may be generated from the linked read requests, and the memory regions respectively corresponding to the read requests may be read simultaneously as shown in FIG. 2B, through the one read command. The link unit 120 may determine whether memory regions are possible to be simultaneously read, based on one or more among chip addresses, plane addresses, block addresses and row addresses of the memory regions.

While it is illustrated in FIG. 2B that a read operation is possibly to be performed simultaneously for all of the four planes PN0 to PN3, it is to be noted that a read operation may be performed simultaneously for only some of the planes PN0 to PN3.

FIG. 2C is a diagram illustrates a case where read requests may not be linked.

Referring to FIG. 2C, selected memory regions 203 to 206 may not correspond to the same block address and the same row address in the respective planes PN0 to PN3. The selected memory regions 203 to 206 may not be coupled to a common word line. In this case, the nonvolatile memory device 200 may not read simultaneously the selected memory regions 203 to 206, due to the structural characteristic thereof.

Referring again to FIG. 1, when memory regions corresponding to read requests may not be read simultaneously as shown in FIG. 2C, the link unit 120 may not link the read requests and cause the read requests to stand by, i.e. delay their executions A stand-by read request may be processed by being linked with new read requests within a predetermined standby time, or may be processed solely without being linked with any read request, when the predetermined standby time passes.

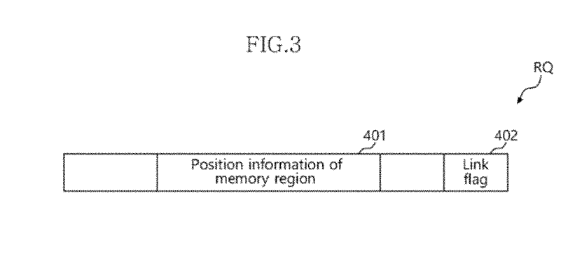

FIG. 3 is a diagram illustrating an example of a read request RQ generated by the request generation unit 110 shown in FIG. 1.

Referring to FIG. 3, the request generation unit 110 may generate, when it is necessary to read data from the nonvolatile memory device 200, the read request RQ which includes a position information 401 on a memory region where the data is stored. The link unit 120 may determine whether it is possible to link read requests, by referring to the position information 401 included in the read request RQ.

According to an embodiment, the request generation unit 110 may set a link flag 402 by sorting a read request RQ which should be quickly processed, according to the attribute of the read request RQ. For example, the attribute of the read request RQ may be associated with the use of data to be read. That is, the attribute of the read request RQ may be associated with whether the data is to be transmitted to the external device or the data is to manage the nonvolatile memory device 200. Otherwise, the attribute of the read request RQ may be associated with the priority of the, read request RQ.

In detail, when the read request RQ should be immediately processed by skipping the determination of the link unit 120 the request generation unit 110 may disable the link flag 402. For example, the request generation unit 110 may set the link flag 402 to “0.” When processing of the read request RQ may be delayed more or less and read requests which are possible to be linked are to be generated successively, the request generation unit 110 may enable the link flag 402. For example, the request generation unit 110 may set the link flag 402 to “1.” Therefore, the link unit 120 may determine whether the read request RQ is possible to be linked, when the link flag 402 is set to “1.” When the link flag 402 is set to “0,” the link unit 120 may control the command generation unit 130 such that the read request RQ may be processed immediately without being determined in terms of whether it is possible to be linked.

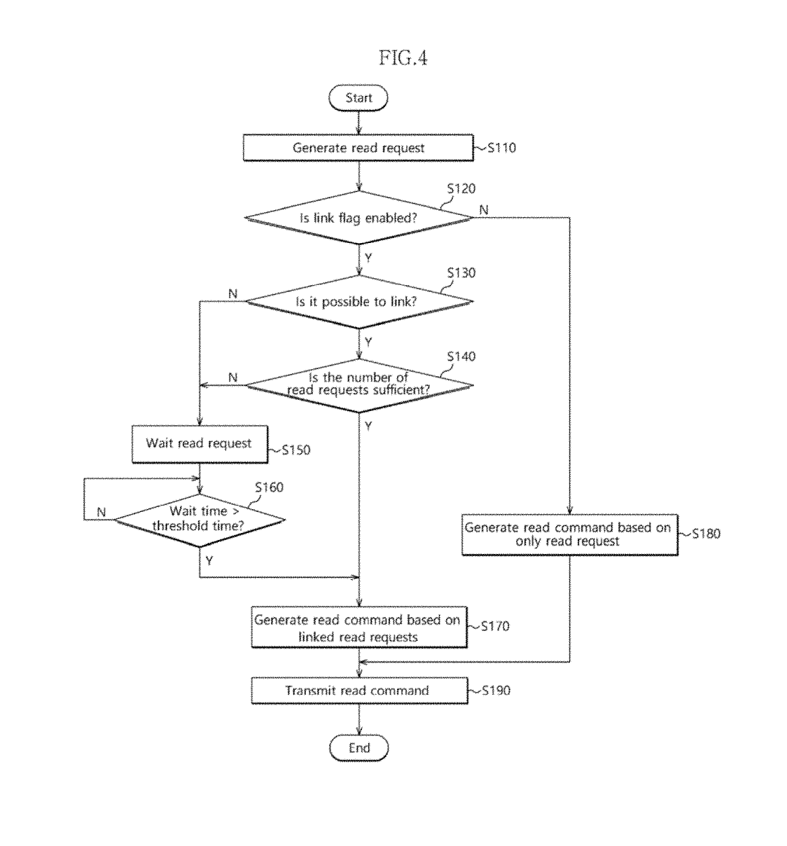

FIG. 4 is a flow chart illustrating a method for operating the data storage device 10 of FIG. 1.

Hereinbelow, the method for operating the data storage device 10 will be described in detail with reference to FIGS. 1 to 4.

At step S110, the request generation unit 110 may generate a read request to read data from the nonvolatile memory device 200. The request generation unit 110 may generate the read request which includes a position information 401 on a memory region where the data to be read is stored. The request generation unit 110 may set a link flag 402 according to the attribute of the read request.

At step S120, the link unit 120 may determine whether the link flag 402 is enabled in the read request generated by the request generation unit 110. When the link flag 402 is enabled, the process may proceed to step S130. When the link flag 402 is disabled, the process may proceed to step S180.

At step S180, when the link flag 402 is disabled (the step S120, No), the command generation unit 130 may generate a read command based on only the current read request. Namely, the determination of the link unit 120 as to whether the read request is possible to be linked may be skipped.

At step S130, when the link flag 402 is enabled (the step S120, Yes), the link unit 120 may determine, based on information on the memory region corresponding to the read request and one or more memory regions corresponding to one or more stand-by read requests, whether the read request is possible to be linked with at least one of the stand-by read requests. The link unit 120 may determine whether it is possible to link the read request with at least one of the stand-by read requests, by determining whether the memory region corresponding to the read request and a memory region corresponding to the at least one stand-by read request may be read simultaneously. For example, as stated memory regions that are accessible by the same word line may be accessed simultaneously. When the read request is possible to be linked with at least one stand-by read request, the link unit 120 may link the read request with the at least one stand-by read request. When the read request is possible to be linked with at least one stand-by read request (S130, Yes), the process proceeds to step S140. When the read request is not possible to be linked with at least one stand-by read request (S130, No), the process proceeds to step S150.

At the step S140, the link unit 120 may determine whether the number of read requests which are possible to be linked is sufficient. For example, the link unit 120 may determine whether the number of read requests which are possible to be linked is four, based on the number of the planes PN0 to PN3 of FIG. 2A. When the number of read requests is sufficient (S140, Yes), the process may proceed to step S170. When the number of read requests is not sufficient (S140, No), the process may proceed to the step S150.

At the step S150, the link unit 120 may cause the read request to stand by. While the read request is put in stand-by, i.e., a mode in which the read request waits to be executed, read requests which are subsequently generated may be determined as to whether they are possible to be linked with the standby read request and may be linked with the stand-by read request, based on the process shown in FIG. 4.

At step S160, the link unit 120 may determine whether a wait time of the read request (also referred to as a standby time) exceeds a threshold time. When the standby time exceeds the threshold time (S160, Yes), the process may proceed to the step S170. When the standby time does not exceed the threshold time (S160 No the process may remain at the step S160.

At step S170, the command generation unit 130 may generate a read command based on the linked read requests. If a read request is not linked with any read request while it is in stand-by mode, the command generation unit 130 may generate a read command based on only the read request.

At step S190, the command generation unit 130 may transmit the read command to the nonvolatile memory device 200. Accordingly, when a read command is generated from the linked read requests, the nonvolatile memory device 200 may read data simultaneously from memory regions corresponding to the linked read requests.

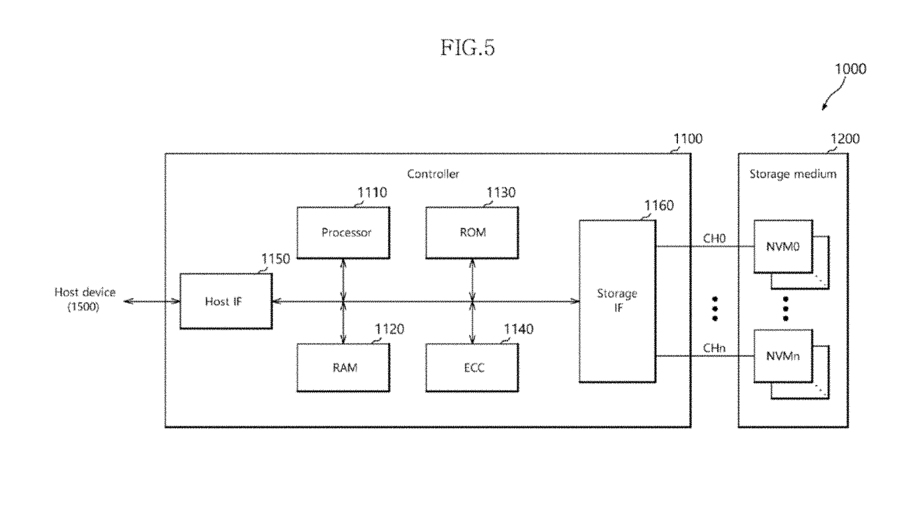

FIG. 5 is a block diagram illustrating a solid state drive (SSD) 1000 in accordance with an embodiment of the present invention.

The SSD 1000 may include a controller 1100 and a storage medium 1200.

The controller 1100 may control data exchange between a host device 1500 and the storage medium 1200. The controller 1100 may include a processor 1110, a random access memory (RAM) 1120, a read only memory (ROM) 1130, an error correction code (ECC) unit 1140, a host interface 1150, and a storage medium interface 1160.

A controller 1100 may operate substantially similarly to the controller 100 shown in FIG. 1. The controller 1100 may determine, based on a memory region of a nonvolatile memory device corresponding to a read request and memory regions of the nonvolatile memory device corresponding to one or more stand-by read requests, whether the read request is possible to be linked with at least one of the stand-by read requests. When the read request is possible to be linked with at least one stand-by read request, the controller 1100 may generate a read command based on the read request and the linked at least one stand-by read request. When the read request is not possible to be linked with at least one stand-by read request, the controller 1100 may cause the read request to stand by.

The processor 1110 may control the operations of the controller 1100. For example, the processor 1110 may store data in the storage medium 1200 and read stored data from the storage medium 1200, according to data processing requests from the host device 1500. To efficiently manage the storage medium 1200, the processor 1110 may control the internal operations of the SSD 1000 such as a merge operation, a wear leveling operation, and so forth.

The RAM 1120 may store programs and program data to be used by the processor 1110. The RAM 1120 may temporarily store data received from the host interface 1150 before transferring it to the storage medium 1200, and may temporarily store data received from the storage medium 1200 before transferring it to the host device 1500.

The ROM 1130 may store program codes to be read by the processor 1110. The program codes may include commands to be processed by the processor 1110, for the processor 1110 to control the internal units of the controller 1100.

The ECC unit 1140 may encode data to be stored in the storage medium 1200, and may decode data read from the storage medium 1200. The ECC unit 1140 may detect and correct an error occurred in data, according to an FCC algorithm.

The host interface 1150 may exchange data processing requests, data, etc. with the host device 1500.

The storage medium interface 1160 may transmit control signals and data to the storage medium 1200. The storage medium interface 1160 may receive data from the storage medium 1200. The storage medium interface 1160 may be coupled with the storage medium 1200 through a plurality of channels CH0 to CHn.

The storage medium 1200 may include a plurality of nonvolatile memory devices NVM0 to NVMn. Each of the plurality of nonvolatile memory devices NVM0 to NVMn may perform an operation, for example, a write operation and a read operation according to control of the controller 1100.

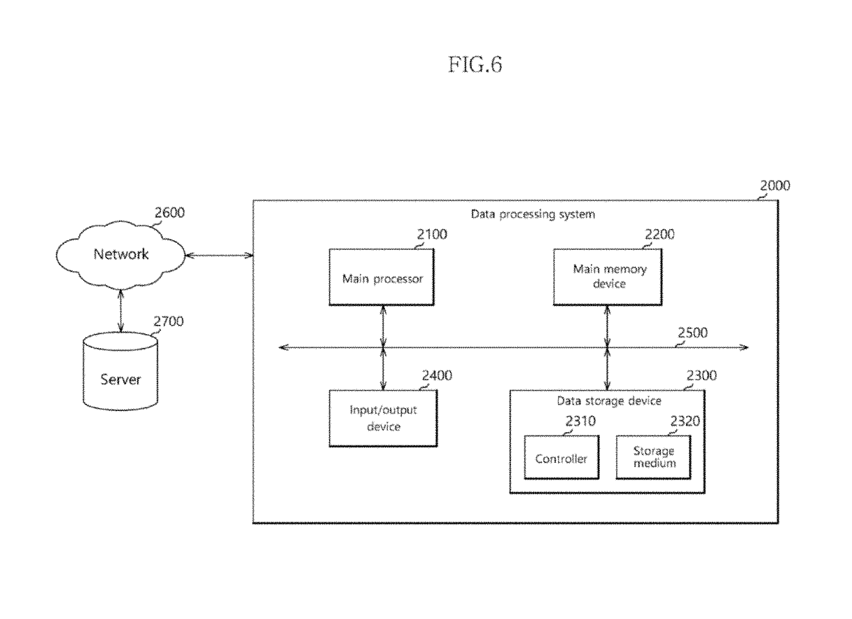

FIG. 6 is a block diagram illustrating a data processing system 2000 to which a data storage device in accordance with an embodiment is applied.

The data processing system 2000 may include a computer, a laptop, a netbook, a smart phone, a digital television (TV), a digital camera, a navigator, etc. The data processing system 2000 may include a main processor 2100, a main memory device 2200, a data storage device 2300, and an input/output device 2400. The internal units of the data processing system 2000 may exchange data, control signals etc. through a system bus 2500.

The main processor 21 00 may control general operations of the data processing system 2000. The main processor 2100 may be a central processing unit such as a microprocessor. The main processor 2100 may execute a software such as an operation system, an application, a device driver, and so forth, on the main memory device 2200.

The main memory device 2200 may store programs and program data to be used by the main processor 2100. The main memory device 2200 may temporarily store data to be transmitted to the data storage device 2300 and the input/output device 2400.

The data storage device 2300 may include a controller 2310 and a storage medium 2320. The data storage device 2300 may be configured and operate in a manner substantially similar to the data storage device 10 shown in FIG. 1.

The input/output device 2400 may include a keyboard, a scanner, a touch screen, a screen monitor, a printer, a mouse, or the like, capable of exchanging data with a user, such as receiving a command from the user for controlling the data processing system 2000 or providing a processed result to the user.

According to an embodiment, the data processing system 2000 may communicate with at least one server 2700 through a network 2600 such as a local area network (LAN), a wide area network (WAN), a wireless network, and so on. The data processing system 2000 may include, a network interface (not shown) to access the network 2600. While various embodiments have been described above, it will be understood to those skilled in the art that the embodiments described are examples only. Accordingly, the data storage device and the operating method thereof described herein should not be limited based on the described embodiments. It will be apparent to those skilled in the art that various changes and modifications may be made without departing from the spirit and scope of the invention as defined in the following claims.

What is claimed is:

1. A data storage device comprising:
a nonvolatile memory device; and
a controller configured to generate a read command based on information on a memory region of the nonvolatile memory device corresponding to a read request and at least one memory region of the nonvolatile memory device corresponding to at least one stand-by read request,
wherein the nonvolatile memory device simultaneously reads data stored in the memory region and data stored in the at least one memory region, in response to the read command.

2. The data storage device according to claim 1, wherein the controller generates the read command when it is determined based on information on the memory region and the at least one memory region that the read request is possible to be linked with the at least one stand-by read request.

3. The data storage device according to claim 2, wherein the controller determines whether the read request is possible to be linked with the at least one stand-by read request, based on at least one of chip addresses, plane addresses, block addresses and row addresses of the memory region and the at least one memory region.

4. The data storage device according to claim 1, wherein the controller does not generate the read command and causes the read request to stand by, when it is determined based on the memory region and the at least one memory region that the read request is not possible to be linked with the at least one stand-by read request.

5. The data storage device according to claim 1, wherein the controller generates the read command or does not generate the read command and causes the read request to stand by, based on the number of the stand-by read requests.

6. A data storage device comprising:
a nonvolatile memory device; and
a controller configured to determine, based on information on a memory region of the nonvolatile memory device corresponding to a read request and at least one memory region of the nonvolatile memory device corresponding to at least one stand-by read request among a plurality of stand-by read requests, whether the read request is possible to be linked with the at least one stand-by read request, and cause the read request to stand by when the read request is not possible to be linked with the at least one stand-by read request.

7. The data storage device according to claim 6, wherein the controller determines whether the read request is possible to be linked with the at least one stand-by read request, by determining whether data stored in the memory region and data stored in the at least one memory region are possible to be read simultaneously.

8. The data storage device according to claim 6, wherein the controller generates a read command based on the read request and the at least one stand-by read request and transmits the read command to the nonvolatile memory device, when the read request is possible to be linked with the at least one stand-by read request.

9. The data storage device according to claim 6 wherein the controller determines whether the number of the at least one stand-by read request is sufficient when the read request is possible to be linked with the at least one stand-by read request, and causes the read request to stand by when the number of the at least one stand-by read request is not sufficient.

10. The data storage device according to claim 9 wherein the controller generates the read command based on the read request and the at least one stand-by read request and transmits the read command to the nonvolatile memory device, when the number of the at least one stand-by read request is sufficient.

11. The data storage device according to claim 6, wherein the controller determines whether a standby time of the read request has reached a threshold time, and generates the read command based on the read request and at least one read request which are possible to be linked with the read request and transmits the read command to the nonvolatile memory device, when the standby time has reached the threshold time.

12. The data storage device according to claim 6, wherein the controller sets a link flag in the read request, based on an attribute of the read request, generates the read command based on the read request by skipping, determination as to whether the read request is possible to be linked, and transmits the read command to the nonvolatile memory device.

13. A method for operating a data storage device, comprising:
determining, based on information on a memory region corresponding to a read request and at least one memory region corresponding to at least one stand-by read request, whether the read request is possible to be linked with the at least one stand-by read request; and
causing the read request to stand by, when the read request is not possible to be linked with the at least one stand-by read request.

14. The method according to claim 13, wherein the determining of whether the read request is possible to be linked with the at least one stand-by read request comprises:
determining whether data stored in the memory region of the read request and data stored in the memory region of the at least one stand-by read request are possible to be read simultaneously.

15. The method according to claim 13, further comprising:
generating a read command based on the read request and at least one linked stand-by read request when the read request is possible to be linked with the at least one stand-by read request; and
transmitting the read and to the nonvolatile memory device.

16. The method according to claim 13, further comprising:
determining whether the number of the at least one stand-by read request is sufficient, when the read request is possible to be linked with the at least one stand-by read request; and
causing the read request to stand by, when the number of the at least one stand-by read request is not sufficient.

17. The method according to claim 16 further comprising:
generating the read command based on the read request and the at least one stand-by read request, when the number of the at least one stand-by read request is sufficient; and
transmitting the read command to the nonvolatile memory device.

18. The method according to claim 16, further comprising:
determining whether a standby time of the read request has reached a threshold time;
generating the read command based on the read request and at least one stand-by read request which are possible to be linked with the read request, when the standby time has reached the threshold time; and
transmitting the read command to the nonvolatile memory is device.

19. The method according to claim 13, further comprising:
setting a link flag in the read request based on an attribute of the read request;
generating the read command based on the read request by skipping a determination as to whether the read request is possible to be linked, according to the link flag; and
transmitting the read command to the nonvolatile memory device.
